(19) United States
(12) Patent Application Publication
(10) Pub. No.: US 2024/0038210 A1
(43) Pub. Date: Feb. 1, 2024

(54) MULTIBAND FLEXURAL WAVE ABSORBERS

(71) Applicant: Toyota Motor Engineering & Manufacturing North America, Inc., Plano, TX (US)

(72) Inventors: Xiaopeng Li, Ann Arbor, MI (US); Ziqi Yu, Ann Arbor, MI (US); Taehwa Lee, Ann Arbor, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/875,586

(22) Filed: Jul. 28, 2022

(51) Int. Cl. G10K 11/168; F16F 15/02

(52) U.S. Cl. CPC G10K 11/168; F16F 15/02; F16F 2228/007

(57) ABSTRACT

A flexural wave absorber includes an L-shaped cantilever beam lossy acoustic black hole disposed on a surface of a mechanical structure and an L-shaped cantilever beam lossless acoustic black hole disposed on the surface and spaced apart from the L-shaped cantilever beam lossy acoustic black hole a predefined distance. The L-shaped cantilever beam lossy acoustic black hole and the L-shaped cantilever beam lossless acoustic black hole, in combination, are configured to asymmetrically absorb a plurality of different frequencies of flexural waves within at least a 2000 Hz frequency band acting on the mechanical structure. The L-shaped cantilever beam lossy acoustic black hole and the L-shaped cantilever beam lossless acoustic black hole can both include a projecting beam with an outer surface or an inner surface having power law profile.

### TECHNICAL FIELD

The present disclosure relates generally to flexural wave absorbers, and particularly to acoustic black hole flexural wave absorbers.

### BACKGROUND

Sound radiation (i.e., noise) is typically the result of flexural waves, also known as bending waves, propagating across a surface of a mechanical structure (also referred to herein simply as “structure”) and deforming the structure transversely to the surface. In addition, flexural waves are generally more complicated compared to compression or shear waves acting on a structure since flexural waves are dependent on the material and geometric properties of the structure and can be dispersive since flexural waves with different frequencies travel at different speeds.

Traditional solutions for absorbing flexural waves include using dampening materials or nonlinear materials. However, these solutions reduce the bending stiffness of a structure and/or add additional mass to the structure. In addition, traditional solutions fail to absorb low frequency flexural waves such that different and/or broad frequency domains are absorbed.

The present disclosure addresses issues related to the flexural wave absorbers, and other issues related to flexural wave absorption.

### SUMMARY

This section provides a general summary of the disclosure and is not a comprehensive disclosure of its full scope or all of its features.

In one form of the present disclosure, a flexural wave absorber includes a first acoustic black hole (ABH) disposed on a surface of a structure and a second ABH disposed on the surface and spaced apart from the first ABH a predefined distance. Also, the first ABH and the second ABH, in combination, are configured to asymmetrically absorb a plurality of frequencies of flexural waves acting on the structure such that the flexural wave absorber provides multiband frequency absorption.

In another form of the present disclosure, a flexural wave absorber includes a lossy ABH disposed on a surface of a structure and a lossless ABH disposed on the surface and spaced apart from the lossy ABH a predefined distance. The lossy ABH and the lossless ABH, in combination, are configured to asymmetrically absorb a plurality of different frequencies of flexural waves acting on the structure and the plurality of different frequencies span a range of at least a 2000 Hz.

In still another form of the present disclosure, a flexural wave absorber includes a mechanical structure with a surface, an L-shaped cantilever beam lossy ABH disposed on the surface, and an L-shaped cantilever beam lossless ABH disposed on the surface and spaced apart from the L-shaped cantilever beam lossy ABH a predefined distance. The L-shaped cantilever beam lossy ABH and the L-shaped cantilever beam lossless ABH, in combination, are configured to asymmetrically absorb a plurality of different frequencies of flexural waves acting on the mechanical structure and the plurality of different frequencies span a range of at least a 2000 Hz.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A a tapered wedge acoustic black hole;

FIG. 1B shows a spiral acoustic black hole;

FIG. 1C shows a tubular acoustic black hole;

FIG. 1D shows two-dimensional circular acoustic black hole;

FIG. 1E shows a one-side slot acoustic black hole;

FIG. 1F shows a two-sided slot acoustic black hole;

FIG. 2 shows a flexural wave absorber according to the teachings of the present disclosure;

FIG. 3 is a plot of absorption coefficient as a function of flexural wave frequency for the flexural wave absorber shown in FIG. 2 and for flexural waves propagating from left to right (+x direction) and right to left (−x direction); and

FIG. 4 illustrates a structure with flexural wave absorbers according to one form of the present disclosure;

FIG. 5 illustrates a structure with flexural wave absorbers according to another form of the present disclosure; and

FIG. 6 illustrates a structure with flexural wave absorbers according to still another form of the present disclosure.

### DETAILED DESCRIPTION

The present disclosure provides flexural wave absorbers for multiband flexural wave frequencies and/or a broad range of flexural wave frequencies. The flexural wave absorbers include a first acoustic black hole (ABH) disposed on a surface of a structure and a second acoustic black hole disposed on the surface and spaced apart from the first acoustic black a predefined distance. In some variations the first ABH and the second ABH are coupled ABHs, and in at least one variation the coupled ABHs include a lossy ABH and a lossless ABH. As used herein, the phrase “coupled ABHs” refers to two or more ABHs disposed on a structure with a coupling coefficient characterizing interaction between the two or more ABHs.

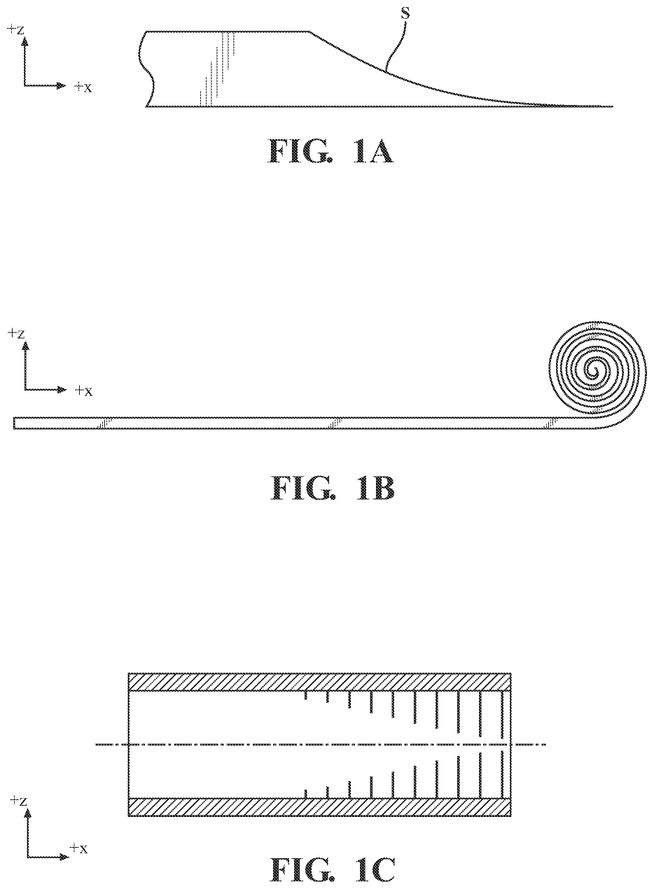

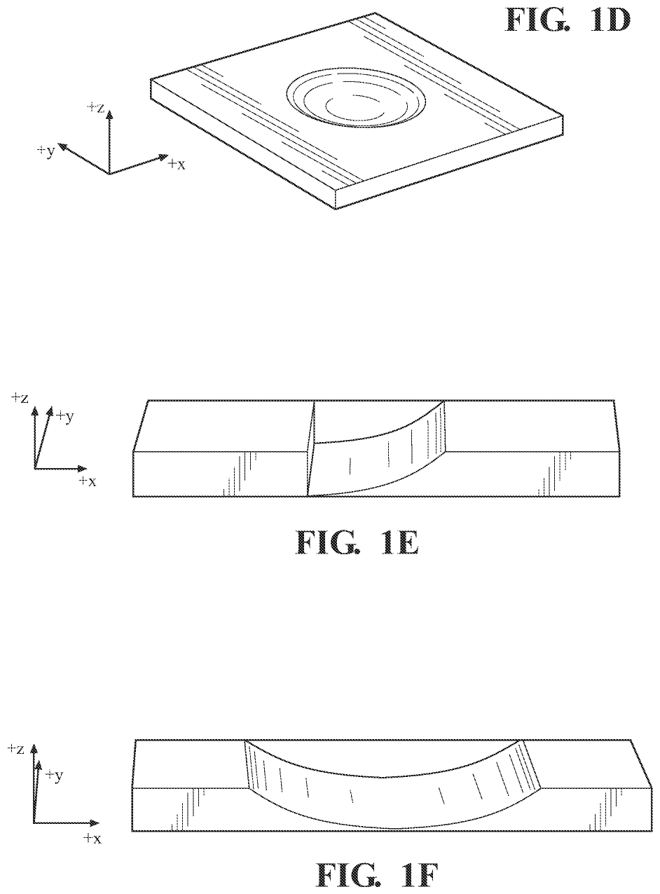

Not being bound by theory, ABHs can provide passive vibration control by embedding or attaching a local inhomogeneity in or onto a thin-wall structure, e.g., a beam or panel, among others. For example, and with reference to FIG. 1A, the inhomogeneity is generally characterized by a power law variation in wall thickness, i.e., the inhomogeneity includes a surface ‘S’ with a power law profile shape (also referred to herein simply as “power law profile”). In addition, and ideally, when the wall thickness equals zero, wave speed of a flexural wave traveling along the inhomogeneity (+x direction in FIG. 1A) decreases to zero and the flexural wave is completely absorbed. Examples of ABHs include beams with a power law taper (sometimes referred to as a tapered wedge ABH (FIG. 1A)), spiral ABHs (e.g., see FIG. 1B), acoustic tubes with axially varying impedance formed by interior branch discs of decreasing inner diameters (e.g., see FIG. 1C), two-dimensional circular ABHs (e.g., see FIG. 1D), one-side slot ABHs (e.g., see FIG. 1E), and two-sided slot ABHs (e.g., see FIG. 1F).

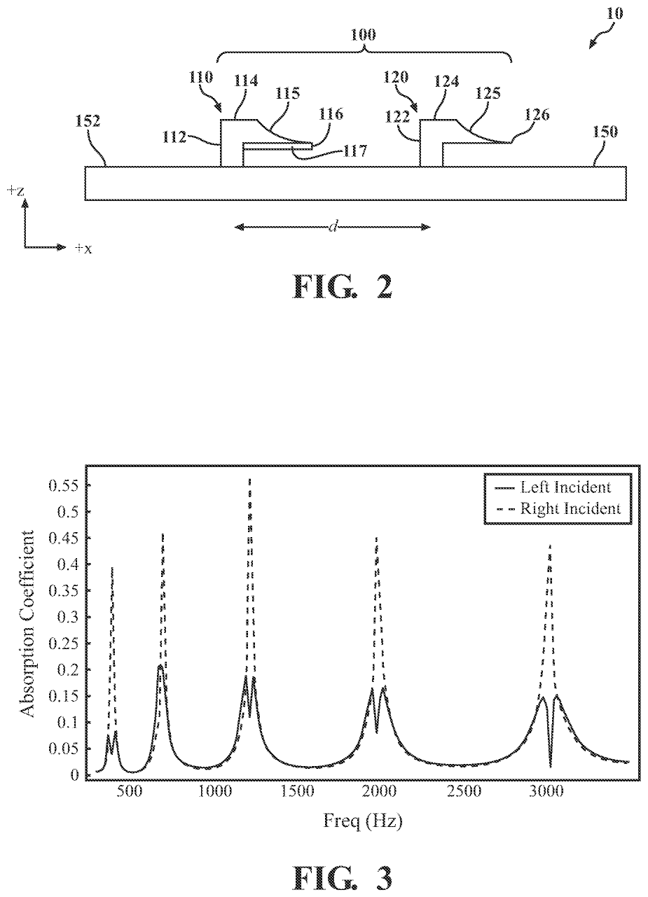

Referring now to FIG. 2, a flexural wave absorber 10 according the present disclosure includes a first ABH 110 disposed on a surface 152 of a structure 150 (e.g., a host beam) and a second ABH 120 disposed on the surface 152 and spaced a predefined distance ‘d’ from the first ABH 110. In some variations, the first ABH 110 and the second ABH 120 define coupled ABHs. As used herein, the phrase “coupled ABHs” refers to two or more ABHs disposed on a mechanical structure with a coupling coefficient characterizing interaction between the two or more ABHs. Also, the first ABH 110 and the second ABH 120 are illustratively shown as tapered wedge ABHs, however it should be understood that the first ABH 110 and/or the second ABH 120 can be other types of ABHs such as those shown in FIGS. 1B-1F, among others.

The first ABH 110 includes a power law profile surface 115 and the second ABH 120 includes a power law profile surface 125. And while FIG. 1 shows an upper (+z direction) surface of the first ABH 110 having the power law profile surface 115 and an upper surface of the second ABH 120 having the power law profile surface 125, in some variations a lower (−z direction) surface of the first ABH 110 has the power law profile surface 115 and/or a lower surface of the second ABH has the power law profile surface 125.

In some variations, the first ABH 110 is a cantilever beam ABH (e.g., an L-shaped cantilever beam ABH) with a surface attachment beam 112 and a projecting beam 114 extending from the surface attachment beam 112 and/or the second ABH 120 is a cantilever ABH with a surface attachment beam 122 and a projecting beam 124 extending from the surface attachment beam 122. In such variations, the projecting beam 114 can include the power law profile surface 115 and the projecting beam 124 can include the power law profile surface 125.

In at least one variation, the first ABH 110 is a lossy ABH and the second ABH 120 is a lossless ABH. And in such variations, the power law profile surface 115 can have a distal or terminal end 116 that is truncated, i.e., has a non-zero thickness, and the power law profile surface 125 can have a distal or terminal end 126 with a zero thickness. Also, a damping layer 117 can extending along and be attached to the lower surface of the projecting beam 114 or the power law profile surface 115 (not shown). And while FIG. 1 shows an upper (+z direction) surface of the projecting beam 114 having the power law profile surface 115 and an upper surface of the projecting beam 124 having the power law profile surface 125, in some variations a lower (−z direction) surface of the projecting beam 114 has the power law profile surface 115 and/or a lower surface of the projecting beam 124 has the power law profile surface 125. As used herein, the phrase “zero thickness” refers to a minimum thickness of a distal or terminal end of a projecting beam that is obtainable using known manufacturing techniques such as machining, laser machining, chemical machining, electrochemical machining, and additive manufacturing, among others. For example, in some variations a zero thickness of a distal or terminal end of projecting beam with a power law profile surface is between 0.1 millimeters (mm) and 0.001 mm.

The surface attachment beams 112, 122 and the projecting beams 114, 124 can be made from any material suitable for flexural wave absorption including, but not limited to, metals, alloys, polymers, and composites, among others. Also, the damping layer 117 can be made from any material suitable for damping flexural waves including, but not limited to polymers, natural rubber, and piezoelectric materials with a negative capacitance shunting circuit, among others.

Referring now to FIG. 3, simulation of the coupled ABHs 100 subjected to flexural waves with frequencies ranging from about 10 Hz to about 3500 Hz propagating left to right (+x direction) and from right to left (−x direction) is shown. The simulations assumed the surface attachment beams 112, 122 had a thickness (z direction) equal to 5 mm, a length (x direction) equal to 5 mm, and a width (y direction) equal to 6 mm. Also, the projecting beams 114, 124 had a thickness (z direction) adjacent to the surface attachment beams equal to 1 mm, a width (y direction) equal to 6 mm, and a power law profile surface 115, 125 with a profile obeying the relation z=εx² with ε=0.35. The length (x direction) of the projecting beam 114, 124 was 60 mm and damping was added to the damping layer 117. The material of surface attachment beams 112, 122 and the projecting beams 114, 124 were modeled as aluminum beams and the host beam 150 was modeled as an aluminum beam having a width equal to 12.7 mm and a thickness equal to 3 mm. In some variations, the ABH 110 and the ABH 120 are disposed on the same surface (plane) of the structure 150, while in other variations the ABH 110 and the ABH 120 are disposed on opposite surfaces or planes of the structure 150.

As shown in FIG. 3, the coupled ABHs 100 exhibited absorption coefficients of about 0.4, 0.45, 0.56, 0.45, and 0.44 for flexural waves propagating in the left to right (+x direction) and having frequencies of about 300 Hz, 700 Hz, 1250 Hz, 2000 Hz, and 3000 Hz, respectively. Also, the coupled ABHs 100 exhibited absorption coefficients of about 0.075, 0.2, 0.18, 0.16, and 0.15 for flexural waves propagating in the right to left (−x direction) and having frequencies of about 300 Hz, 700 Hz, 1250 Hz, 2000 Hz, and 3000 Hz, respectively. Accordingly, the coupled ABHs 100, and other coupled ABHs disclosed herein, provide asymmetric multiband absorption of flexural waves and it should also be understood that the geometric properties and/or material properties of the coupled ABHs 100, and other coupled ABHs disclosed herein, can be adjusted or optimized such that desired flexural wave frequencies are absorbed in an asymmetric manner (e.g., in an extremely asymmetric manner).

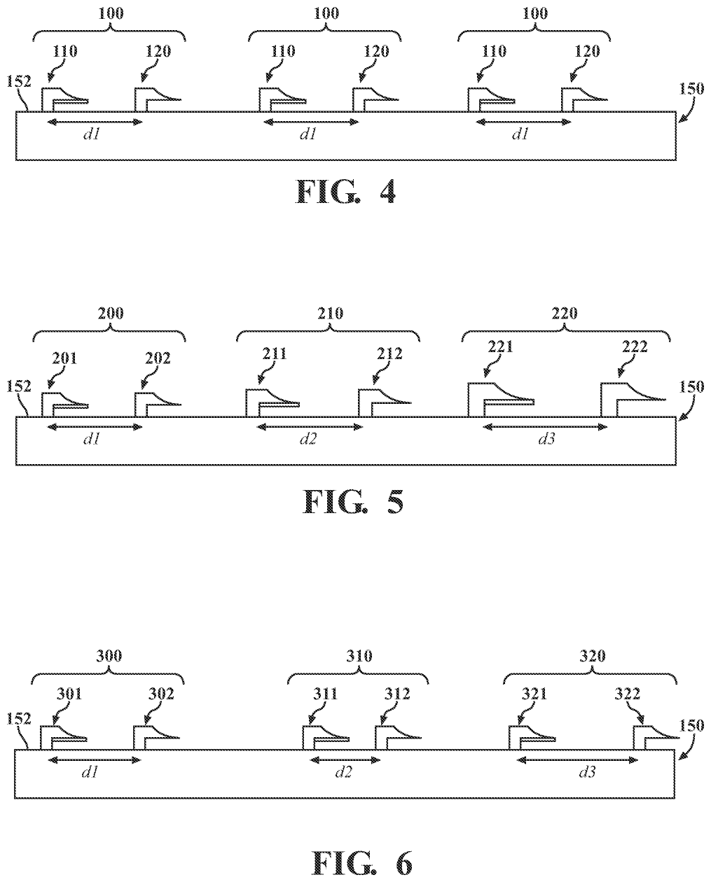

Referring to FIG. 4, the structure 150 with a plurality of coupled ABHs 100 disposed on the surface 152 according to one form of the present disclosure is shown (three coupled ABHs shown for illustrative purposes only). The plurality of coupled ABHs 100 have the same geometric properties, i.e., the size and shape of coupled ABHs 100 are equivalent to each other and the distance (d1) between the first ABH 110 and the second ABH 120 is the same for each of the coupled ABHs 100. In some variations, the material properties of the coupled ABHs are the same, while in other variations the material properties of at least one of the coupled ABHs 100 is different than the material properties of at least one of the other coupled ABHs 100.

Accordingly, in some variations the coupled ABHs according to the teachings of the present disclosure provide flexural wave absorption using a plurality coupled ABHs having the same size/shape and formed from the same material. While in other variations the coupled ABHs according to the teachings of the present disclosure provide flexural wave absorption using a plurality coupled ABHs having the same size/shape but formed from different materials such that one or more of the coupled ABHs have different flexural wave absorption properties compared to the remaining coupled ABHs.

Referring to FIG. 5, the structure 150 with a plurality of coupled ABHs 200, 210, 220 disposed on the surface 152 according to another form of the present disclosure is shown (three coupled ABHs shown for illustrative purposes only). The coupled ABHs 200 includes a first ABH 201 and a second ABH 202 spaced a predefined distance ‘d1’ from the first ABH 201, the coupled ABHs 210 includes a first ABH 211 and a second ABH 212 spaced a predefined distance ‘d2’ from the first ABH 211, and the coupled ABHs 220 includes a first ABH 221 and a second ABH 222 spaced a predefined distance ‘d3’ from the first ABH 221.

The geometric properties and/or material properties of the coupled ABHs 200 are different than the geometric properties and/or material properties of the coupled ABHs 210, the geometric properties and/or material properties of the coupled ABHs 210 are different than the geometric properties and/or material properties of the coupled ABHs 220, and/or the geometric properties and/or material properties of the coupled ABHs 200 are different than the geometric properties and/or material properties of the coupled ABHs 220. Also, a distance d1 between the first ABH 201 and the second ABH 202 of the coupled ABHs 200 is different than a distance d2 between the first ABH 211 and the second ABH 212 of the coupled ABHs 210, the distance d2 between the first ABH 211 and the second ABH 212 of the coupled ABHs 210 is different than a distance d3 between the first ABH 221 and the second ABH 222 of the coupled ABHs 220, and/or the distance d1 between the first ABH 201 and the second ABH 202 of the coupled ABHs 200 is different than the distance d3 between the first ABH 221 and the second ABH 222 of the coupled ABHs 220.

Accordingly, in some variations the coupled ABHs according to the teachings of the present disclosure provide flexural wave absorption using a plurality coupled ABHs having different sizes, formed from different materials, and/or spaced apart by different distances such that one or more coupled ABHs have different flexural wave absorption properties compared to the remaining coupled ABHs.

Referring to FIG. 6, the structure 150 with a plurality of coupled ABHs 300, 310, 320 disposed on the surface 152 according to still another form of the present disclosure is shown (three coupled ABHs shown for illustrative purposes only). The coupled ABHs 300 includes a first ABH 301 and a second ABH 302 spaced a predefined distance ‘d1’ from the first ABH 301, the coupled ABHs 310 includes a first ABH 311 and a second ABH 312 spaced a predefined distance ‘d2’ from the first ABH 311, and the coupled ABHs 320 includes a first ABH 321 and a second ABH 322 spaced a predefined distance ‘d3’ from the first ABH 321.

In some variations, the material properties of the coupled ABHs 300 are the same as the material properties of the coupled ABHs 310 which are the same as the material properties of the coupled ABHs 320. And in at least one variation, the geometric properties of the first ABH 301 are the same as the geometric properties of the first ABH 311 and the first ABH 321, and the geometric properties of the second ABH 302 are the same as the geometric properties of the second ABH 312 and the second ABH 322. That is, the first ABHs 301, 311, 321 have the same shape and size, and the second ABHs 3302, 312, 322 have the same shape and size. However, and as illustrated in FIG. 5, a distance d1 between the first ABH 301 and the second ABH 302 of the coupled ABHs 300 is different than a distance d2 between the first ABH 311 and the second ABH 312 of the coupled ABHs 310, the distance d2 between the first ABH 311 and the second ABH 312 of the coupled ABHs 310 is different than a distance d3 between the first ABH 321 and the second ABH 322 of the coupled ABHs 320, and the distance d1 between the first ABH 301 and the second ABH 302 of the coupled ABHs 300 is different than the distance d3 between the first ABH 321 and the second ABH 322 of the coupled ABHs 320.

Accordingly, in some variations the coupled ABHs according to the teachings of the present disclosure provide flexural wave absorption using a plurality coupled ABHs having the same shape/size and formed from the same material, but spaced apart from each other by different predefined distances such that one or more coupled ABHs have different flexural wave absorption properties compared to the other coupled ABHs.

It should be understood from the teachings of the present disclosure that flexural wave absorbers that include at least two ABHs are provided and the flexural wave absorbers asymmetrical absorb flexural waves having different frequencies and/or having different ranges of frequencies. That is, multiband flexural wave absorbers are provided.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should be also understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A flexural wave absorber comprising:
a mechanical structure with a surface; and
a first acoustic black hole (ABH) disposed on the surface and a second ABH disposed on the surface and spaced apart from the first ABH a predefined distance, the first ABH and the second ABH, in combination, configured to asymmetrically absorb a plurality of frequencies of flexural waves acting on the mechanical structure.

2. The flexural wave absorber according to claim 1, wherein the first ABH and the second ABH define coupled ABHs.

3. The flexural wave absorber according to claim 1, wherein the first ABH is a lossy ABH and the second ABH is a lossless ABH.

4. The flexural wave absorber according to claim 1, wherein at least one of the first ABH and the second ABH is a cantilever beam ABH.

5. The flexural wave absorber according to claim 4, wherein the cantilever beam ABH is an L-shaped cantilever beam ABH with a projecting beam comprising a power law profile surface.

6. The flexural wave absorber according to claim 5, wherein an outer surface of the projecting beam comprises the power law profile surface.

7. The flexural wave absorber according to claim 1, wherein the first ABH and the second ABH are cantilever beams ABHs.

8. The flexural wave absorber according to claim 7, wherein the cantilever beam ABHs are L-shaped cantilever beam ABHs with projecting beams comprising power law profile surface.

9. The flexural wave absorber according to claim 8, wherein outer surfaces of the projecting beams comprise the power law profile surface.

10. The flexural wave absorber according to claim 1, wherein the first ABH is a lossy ABH comprising an L-shaped cantilever beam with a projecting beam comprising a power law profile.

11. The flexural wave absorber according to claim 10 further comprising a damping layer disposed on an inner surface of the projecting beam.

12. The flexural wave absorber according to claim 11, wherein the L-shaped cantilever beam is formed from a first material and the damping layer is forming from a second material different than the first material.

13. The flexural wave absorber according to claim 12, wherein the plurality of frequencies of flexural waves acting on the mechanical structure range from about 10 Hz to about 3000 Hz.

14. The flexural wave absorber according to claim 12, wherein the plurality of frequencies of flexural waves acting on the mechanical structure spans at least a 2000 Hz frequency range.

15. A flexural wave absorber comprising:
a mechanical structure with a surface; and
a lossy acoustic black hole (ABH) disposed on the surface and a lossless ABH disposed on the surface and spaced apart from the lossy ABH a predefined distance, the lossy ABH and the lossless ABH, in combination, configured to asymmetrically absorb a plurality of different frequencies of flexural waves acting on the mechanical structure with the plurality of different frequencies spanning at least a 2000 Hz frequency range.

16. The flexural wave absorber according to claim 15, wherein the lossy ABH and the lossless ABH each comprise an L-shaped cantilever beam.

17. The flexural wave absorber according to claim 16, wherein the L-shaped cantilever beam of the lossy ABH and the L-shaped cantilever beam of the lossy ABH each comprise an outer surface with a power law profile surface and the lossy ABH further comprises a damping layer disposed on an inner surface of the L-shaped cantilever beam.

18. A flexural wave absorber comprising:
a mechanical structure with a surface; and
an L-shaped cantilever beam lossy acoustic black hole (ABH) disposed on the surface and an L-shaped cantilever beam lossless ABH disposed on the surface and spaced apart from the L-shaped cantilever beam lossy ABH a predefined distance, the L-shaped cantilever beam lossy ABH and the L-shaped cantilever beam lossless ABH, in combination, configured to asymmetrically absorb a plurality of different frequencies of flexural waves within at least a 2000 Hz frequency band acting on the mechanical structure.

19. The flexural wave absorber according to claim 18, wherein the L-shaped cantilever beam lossy ABH and the L-shaped cantilever beam lossless ABH each comprise an outer surface with a power law profile.

20. The flexural wave absorber according to claim 19, wherein the L-shaped cantilever beam lossy ABH further comprises a damping layer disposed on an inner surface of the L-shaped cantilever beam lossy ABH.
